(19) United States
(12) Patent Application Publication
(10) Pub. No.: US 2025/0086912 A1
(43) Pub. Date: Mar. 13, 2025

(54) DIGITAL SHOWROOM FOR CONDUCTING VEHICLE DEMOS AND CONVERSATIONS WITH PRODUCT EXPERTS

(71) Applicant: Volvo Car Corporation, Göteborg (SE)

(72) Inventors: Garrett GONZALES, San Francisco, CA (US); Caitlyn MOWRY, Bellevue, WA (US); Irfan ALAM, Dublin, CA (US); Denis SHAPIRO, Sunnyvale, CA (US); Yangjun LI, Sunnyvale, CA (US)

(21) Appl. No.: 18/243,248

(22) Filed: Sep. 7, 2023

(51) Int. Cl. G06T 19/20; H04L 51/046

(52) U.S. Cl. CPC G06T 19/20; H04L 51/046; G06T 2219/2012

(57) ABSTRACT

A system for providing vehicle demos and conversations with product experts. The system activates an expert user chat in an expert user interface and activates a customer user chat in a customer user interface. The system further renders a three-dimensional (3D) model of a vehicle in the expert user interface and in the customer user interface. The system further renders controls in the expert user interface that enable an expert user to manipulate the 3D model in the expert user interface, and renders controls in the customer user interface that enable a customer user to manipulate the 3D model in the customer user interface.

### INTRODUCTION

The present disclosure relates generally to the automotive fields. Customers conventionally visit dealer showrooms in person when shopping for a vehicle. Physically visiting dealerships may be tedious depending on the driving distance to such dealerships. Some dealers enable a prospective customer to visit the dealership virtually via the dealer website, where the customer may view vehicle models and learn of their features. Such websites typically provide vehicle specifications and options, including photos and videos of available vehicles. Such websites may have incomplete information and do not have the same experience as physically visiting a dealership.

The present introduction is provided as background context only and is not intended to be limiting in any manner. It will be readily apparent to those of ordinary skill in the art that the concepts and principles of the present disclosure may be implemented in other applications and contexts equally.

### SUMMARY

The present disclosure relates to a system for providing vehicle demos and conversations with product experts. As described in more detail herein, embodiments enable a customer to conveniently and virtually learn about a vehicle before and/or after purchasing the vehicle. Embodiments also enable a customer user and expert user to converse in a video chat environment, where the customer user may ask questions about a vehicle and the expert user may provide a virtual vehicle demo and/or vehicle orientation of a vehicle.

In one illustrative embodiment, the present disclosure provides a system including one or more processors, and logic encoded in one or more non-transitory computer-readable storage media for execution by the one or more processors. When executed the logic is operable to cause the one or more processors to perform operations including: activating an expert user chat in an expert user interface; activating a customer user chat in a customer user interface; rendering a three-dimensional (3D) model of a vehicle in the expert user interface and in the customer user interface; rendering controls in the expert user interface that enable an expert user to manipulate the 3D model in the expert user interface; and rendering controls in the customer user interface that enable a customer user to manipulate the 3D model in the customer user interface. Optionally, the controls in the expert user interface and the controls in the customer user interface enable the expert user and the customer user to manipulate the 3D model simultaneously. The controls in the expert user interface and the controls in the customer user interface enable the expert user and the customer user to manipulate objects of the 3D model, where the objects represent physical components of the vehicle. The controls in the expert user interface and the controls in the customer user interface enable the expert user and the customer user to manipulate objects of the 3D model, where the objects represent electronic operations of the vehicle. The logic when executed is further operable to cause the one or more processors to perform operations including: enabling the expert user and the customer user to converse with each other via the expert user chat and customer user chat; enabling the expert user and the customer user to configure the vehicle using the controls in the expert user interface and the controls in the customer user interface; and storing vehicle configuration data associated with the vehicle in a database of vehicle data. The logic when executed is further operable to cause the one or more processors to perform operations including: accessing a database of vehicle data; and fetching, from the database, vehicle specifications of the vehicle, where the vehicle specifications include features previously selected by the customer user. The logic when executed is further operable to cause the one or more processors to perform operations including: accessing a database of vehicle data; fetching, from the database, vehicle specifications of the vehicle, where the vehicle had been purchased by the customer user; and enabling the expert user to conduct a vehicle orientation for the customer user.

In another illustrative embodiment, the present disclosure provides a non-transitory computer-readable storage medium with program instructions stored thereon. The program instructions when executed by one or more processors are operable to cause the one or more processors to perform operations including: activating an expert user chat in an expert user interface; activating a customer user chat in a customer user interface; rendering a three-dimensional (3D) model of a vehicle in the expert user interface and in the customer user interface; rendering controls in the expert user interface that enable an expert user to manipulate the 3D model in the expert user interface; and rendering controls in the customer user interface that enable a customer user to manipulate the 3D model in the customer user interface. Optionally, the controls in the expert user interface and the controls in the customer user interface enable the expert user and the customer user to manipulate the 3D model simultaneously. The controls in the expert user interface and the controls in the customer user interface enable the expert user and the customer user to manipulate objects of the 3D model, where the objects represent physical components of the vehicle. The controls in the expert user interface and the controls in the customer user interface enable the expert user and the customer user to manipulate objects of the 3D model, where the objects represent electronic operations of the vehicle. The instructions when executed are further operable to cause the one or more processors to perform operations including: enabling the expert user and the customer user to converse with each other via the expert user chat and customer user chat; enabling the expert user and the customer user to configure the vehicle using the controls in the expert user interface and the controls in the customer user interface; and storing vehicle configuration data associated with the vehicle in a database of vehicle data. The instructions when executed are further operable to cause the one or more processors to perform operations including: accessing a database of vehicle data; and fetching, from the database, vehicle specifications of the vehicle, where the vehicle specifications include features previously selected by the customer user. The instructions when executed are further operable to cause the one or more processors to perform operations including: accessing a database of vehicle data; fetching, from the database, vehicle specifications of the vehicle, where the vehicle had been purchased by the customer user; and enabling the expert user to conduct a vehicle orientation for the customer user.

In a further illustrative embodiment, the present disclosure provides a computer-implemented method for providing vehicle demos and conversations with product experts, the method including: activating an expert user chat in an expert user interface; activating a customer user chat in a customer user interface; rendering a three-dimensional (3D) model of a vehicle in the expert user interface and in the customer user interface; rendering controls in the expert user interface that enable an expert user to manipulate the 3D model in the expert user interface; and rendering controls in the customer user interface that enable a customer user to manipulate the 3D model in the customer user interface. Optionally, the controls in the expert user interface and the controls in the customer user interface enable the expert user and the customer user to manipulate the 3D model simultaneously. The controls in the expert user interface and the controls in the customer user interface enable the expert user and the customer user to manipulate objects of the 3D model, where the objects represent physical components of the vehicle. The controls in the expert user interface and the controls in the customer user interface enable the expert user and the customer user to manipulate objects of the 3D model, where the objects represent electronic operations of the vehicle. The method further includes: enabling the expert user and the customer user to converse with each other via the expert user chat and customer user chat; enabling the expert user and the customer user to configure the vehicle using the controls in the expert user interface and the controls in the customer user interface; and storing vehicle configuration data associated with the vehicle in a database of vehicle data. The method further includes: accessing a database of vehicle data; and fetching, from the database, vehicle specifications of the vehicle, where the vehicle specifications include features previously selected by the customer user.

### BRIEF DESCRIPTION OF THE DRAWINGS

The present disclosure is illustrated and described with reference to the various drawings, in which like reference numbers are used to denote like system components and/or method steps, as appropriate.

FIG. 1 is a block diagram of an example environment for providing vehicle demos and conversations with product experts.

FIG. 2 is a flow chart for providing vehicle demos and conversations with product experts.

FIG. 3 is a block diagram of an example video chat environment, where an expert user and a customer user are viewing the exterior of a vehicle.

FIG. 4 is a block diagram of an example video chat environment, where an expert user and a customer user are viewing the interior of a vehicle.

FIG. 5 is a screen shot of an example video chat, where an expert user and a customer user are manipulating the color of a vehicle.

FIG. 6 is a screen shot of an example video chat, where an expert user and a customer user are manipulating the color of a vehicle.

FIG. 7 is a screen shot of an example video chat, where an expert user and a customer user are manipulating physical components of a vehicle.

FIG. 8 is a screen shot of an example video chat, where an expert user and a customer user are manipulating physical components of a vehicle.

FIG. 9 is a screen shot of an example video chat, where an expert user and a customer user are manipulating electronic components of a vehicle.

FIG. 10 is a screen shot of an example video chat, where an expert user and a customer user are manipulating electronic operations of a vehicle.

FIG. 11 is a screen shot of an example video chat, where an expert user and a customer user are viewing the interior of a vehicle at the front seats.

FIG. 12 is a screen shot of an example video chat, where an expert user and a customer user are viewing the interior of a vehicle at the rear seats.

FIG. 13 is a block diagram of an example network environment of the present disclosure.

FIG. 14 is a block diagram of an example computing system of the present disclosure.

### DETAILED DESCRIPTION

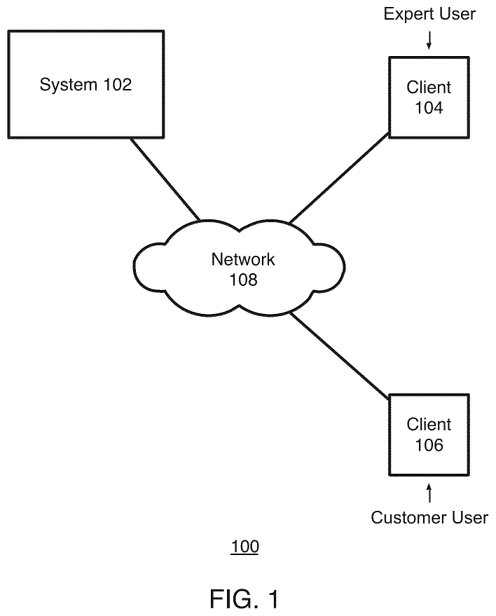

FIG. 1 is a block diagram of an example environment 100 for providing vehicle demos and conversations with product experts. As described in more detail herein, a system 102 enables a video chat between an expert user and a customer user. The system 103 may provide the video chat to the expert user via a client device 104. The system 106 may provide the video chat to the customer user via a client device 106.

The client devices 104 and 106 may communicate with system 102 and/or may communicate with each other directly or via system 102. As shown, the network environment 100 also includes a network 108 through which the system 102 and the client devices 104 and 106 communicate. The network 108 may be any suitable communication network such as a Bluetooth network, a Wi-Fi network, the Internet, etc.

For ease of illustration, FIG. 1 shows one block for each of the system 102 and the client devices 104 and 106, and the network 108. Blocks 102, 104, 106, and 108 may represent multiple systems, client devices, and networks. Also, there may be any number of client devices representing multiple expert users and customer users. In other implementations, environment 100 may not have all of the components shown and/or may have other elements including other types of elements instead of, or in addition to, those shown herein.

While system 102 performs implementations described herein, in other implementations, any suitable component or combination of components associated with system 102 or any suitable processor or processors associated with system 102 may facilitate performing the implementations described herein.

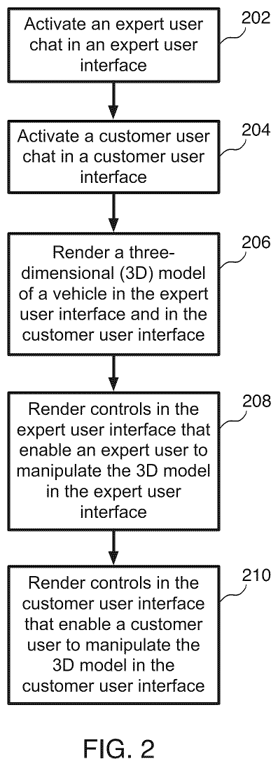

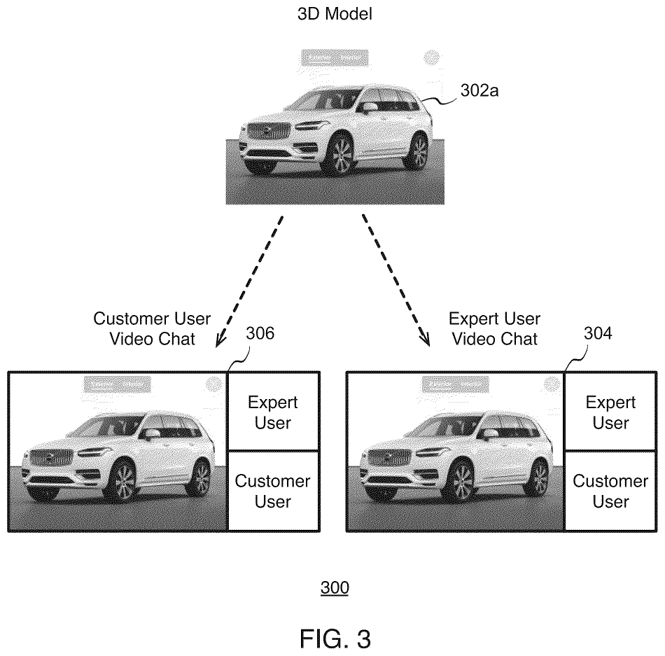

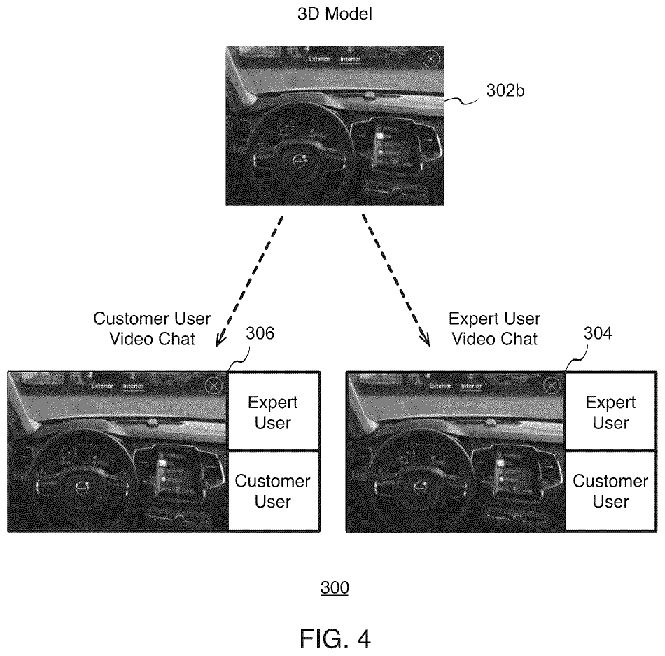

FIG. 2 is a flow chart for providing vehicle demos and conversations with product experts. Referring to both FIGS. 1 and 2, a method is initiated at block 202, where a system such as system 102 activates an expert user chat in an expert user interface. Example embodiments of the expert user chat are described in more detail below in connection with FIGS. 3 and 4.

At block 204, the system 102 activates a customer user chat in a customer user interface. Example embodiments of the customer user chat are described in more detail below in connection with FIGS. 3 through 12.

At block 206, the system 102 renders a three-dimensional (3D) model of a vehicle in the expert user interface and in the customer user interface. The 3D model of the particular vehicle make and model may be selected from the expert and customer user interface, which may be linked to the vehicle manufacture website. The system 102 may render the 3D model as a hi-fidelity video model having little to no lag in rendering. The 3D model presents the vehicle in a more complete format in which the user may view the vehicle from a multitude of different angles and perspectives in real time, which is superior to viewing mere photos of a vehicle. Example embodiments of the 3D model expert are described in more detail below in connection with FIGS. 3 through 12.

FIG. 3 is a block diagram of an example video chat environment 300, where an expert user and a customer user are viewing the exterior of a vehicle. As shown, in various embodiments, the system 102 (FIG. 1) renders a three-dimensional (3D) model 302a of a vehicle. Shown is an exterior view of the 3D model 302a. While one particular perspective view of the exterior of the vehicle is shown, either the expert user or the customer user may manipulate the 3D model to view different angles of the exterior of the vehicle. Examples views are shown and described in more detail herein. The particular type of vehicle may vary, depending on the particular implementation. For example, as shown, the vehicle is a sport utility vehicle (SUV), and may alternatively be another type of vehicle such as a sedan, truck, van, recreational vehicle, etc.

In various embodiments, the system 102 renders the 3D model 302a in an expert user video chat 304 and in a customer user video chat 306. In the video chats 304 and 306, the expert and customer users may view each other along with the rendered 3D model 302a of the vehicle.

FIG. 4 is a block diagram of an example video chat environment, where an expert user and a customer user are viewing the interior of a vehicle. Shown is the same 3D model 302b as that of FIG. 3, except that the expert user video chat 304 and the customer user video chat 306 of FIG. 4 are showing an interior view of the 3D model. The designations 302a and 302b represent different aspects of the same 3D model 302. While one particular perspective view of the interior of the vehicle is shown, either the expert user or the customer user may manipulate the 3D model to view different angles and details of the interior of the vehicle.

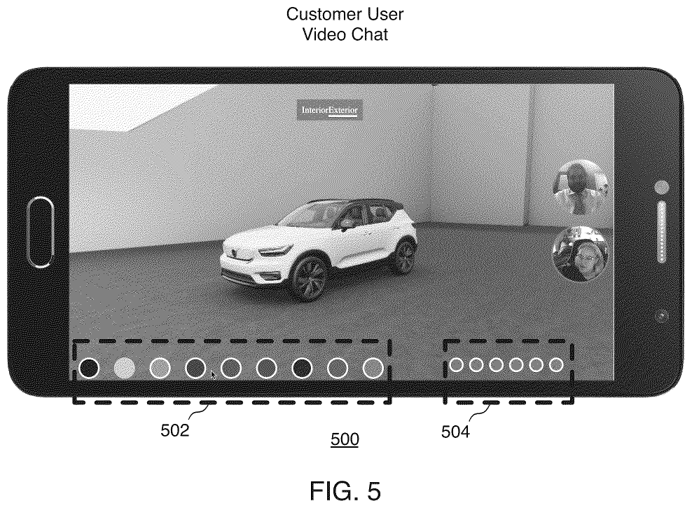

FIG. 5 is a screen shot 500 of an example video chat, where an expert user and a customer user are manipulating the color of a vehicle. For ease of illustration, the customer user video chat is shown on a mobile device. The expert video chat (not shown) looks the same. As shown in this example embodiment, the vehicle has a white exterior color. Whether the customer user or the expert user select or change the color (or other vehicle attribute), the selection or change appears on the respective video chats of both the customer and expert users.

At block 208, the system 102 renders controls in the expert user interface that enable an expert user to manipulate the 3D model in the expert user interface. In the example shown in FIG. 5, both the expert user video chat and the customer user video chat have the same controls. The controls enable a user to manipulate various different aspects of the 3D model, as described herein.

At block 210, the system 102 renders controls in the customer user interface that enable a customer user to manipulate the 3D model in the customer user interface. As indicated above, the customer user video chat is shown in FIG. 5, where both the customer user and the expert user see the same controls and 3D model on their respective client devices (e.g., mobile phone, laptop computer, desktop computer, etc.).

Shown are example sets of controls 502 and 504, which are rendered in the user interfaces and more particularly in the video chats of the respective expert and customer users. Controls 502 enable either user to modify the color of the vehicle. The particular controls may vary, depending on the particular implementations. For example, controls 504 may provide access to menus of more controls. Such controls may include controlling the orientation of the vehicle, opening doors of the vehicle, operating electronic operations of the vehicle, etc., examples of which are described herein.

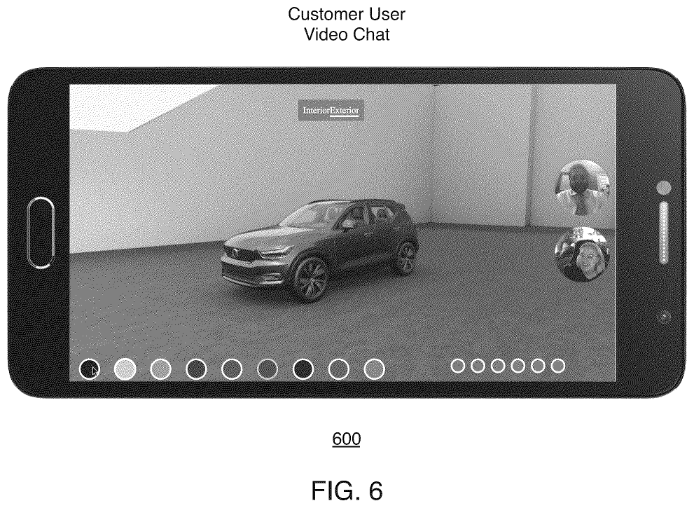

FIG. 6 is a screen shot 600 of an example video chat, where an expert user and a customer user are manipulating the color of a vehicle. As shown in this example embodiment, the vehicle has a dark gray exterior color. In various embodiments, the controls in the expert user interface and the controls in the customer user interface enable the expert user and the customer user to manipulate the 3D model simultaneously. As indicated above, whether the customer user or the expert user select or change the color or other attribute, the selection or change appears on the respective video chats of both the customer and expert users.

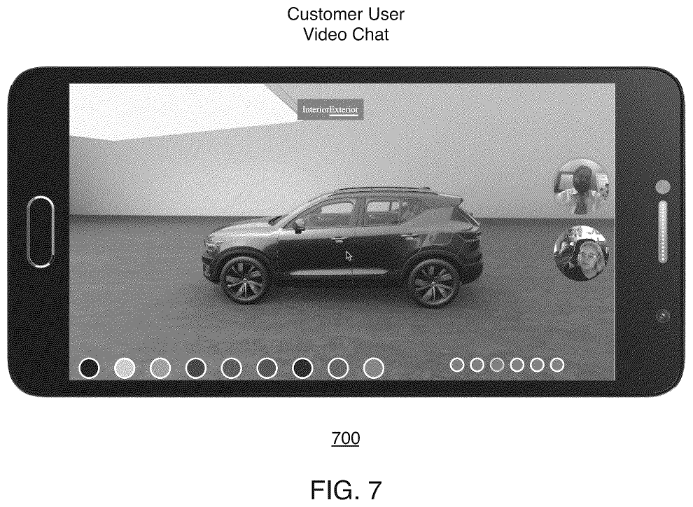

FIG. 7 is a screen shot 700 of an example video chat, where an expert user and a customer user are manipulating physical components of a vehicle. In various embodiments, the controls in the expert user interface and the controls in the customer user interface enable the expert user and the customer user to manipulate objects of the 3D model, where the objects represent physical components of the vehicle. In this example screen shot, the vehicle is oriented to show its side view. Also, the doors are closed.

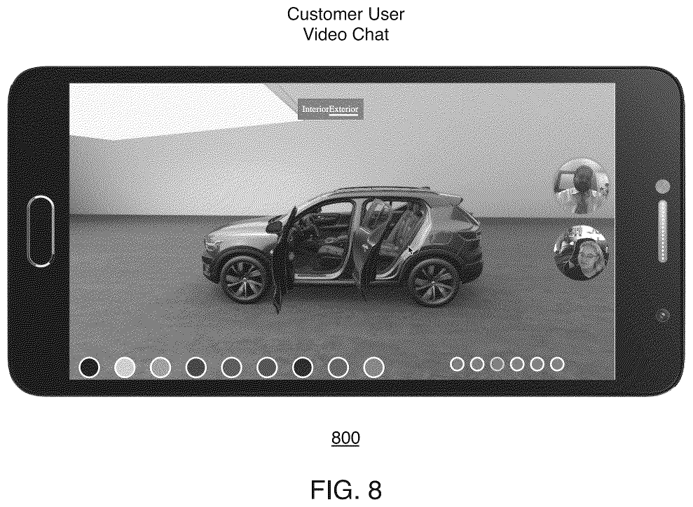

FIG. 8 is a screen shot 800 of an example video chat, where an expert user and a customer user are manipulating physical components of a vehicle. In this screen shot, the vehicle remains oriented to show its side view. Here, either the customer user or the expert user has opened the driver's door and the left rear door. As indicated above, the customer and expert user may manipulate the 3D model simultaneously. For example, the customer user may have opened the driver's door, and the expert user may have opened the left rear door. In various embodiments, the users may manipulate objects of the physical component independently. The particular physical components may vary, depending on the particular implementation. For example, such physical components may include a virtual trunk or frunk in case of an electric vehicle, seats which may be inclined, declined, flipped down, etc.

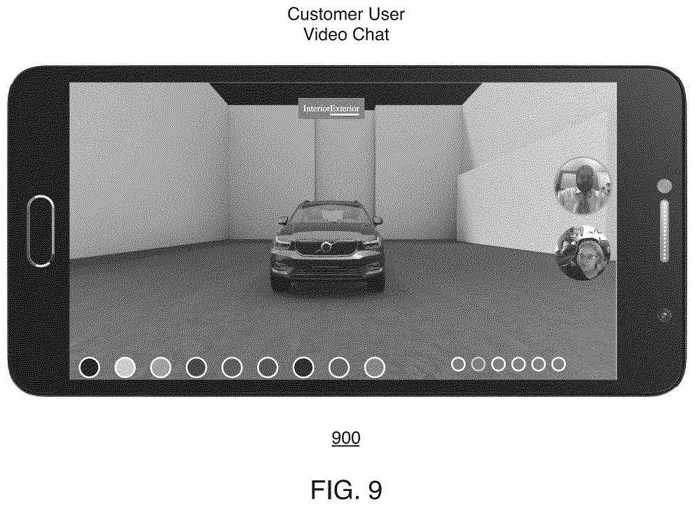

FIG. 9 is a screen shot 900 of an example video chat, where an expert user and a customer user are manipulating electronic operations of a vehicle. In various embodiments, the controls in the expert user interface and the controls in the customer user interface enable the expert user and the customer user to manipulate objects of the 3D model, where the objects represent electronic operations of the vehicle. In this example screen shot, the vehicle is oriented to show its front view. Also, light emitting diode (LED) lights above the headlights are in an off state.

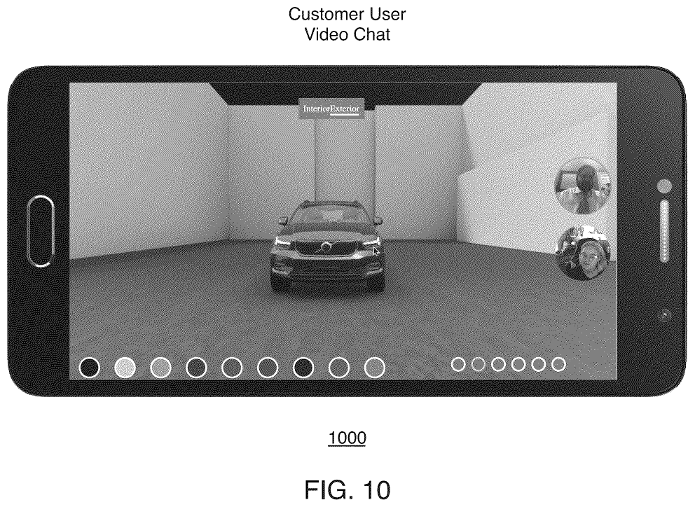

FIG. 10 is a screen shot 1000 of an example video chat, where an expert user and a customer user are manipulating electronic operations of a vehicle. In this screen shot, the vehicle remains oriented to show its front view. Here, either the customer user or the expert user has turned on the LED lights above the headlights, which are shown in an on state. For ease of illustration, FIGS. 9 and 10 shown the LED light toggling from off to on states. The system enables the customer and expert users to manipulate other electronic operations independently. For example, while the customer user toggles the LED lights on and off, the expert user may toggle the headlights on and off simultaneously. Such manipulation of the electronic operations may extend to any electronic operations of the vehicle (e.g., fog lights, interior lights, etc.).

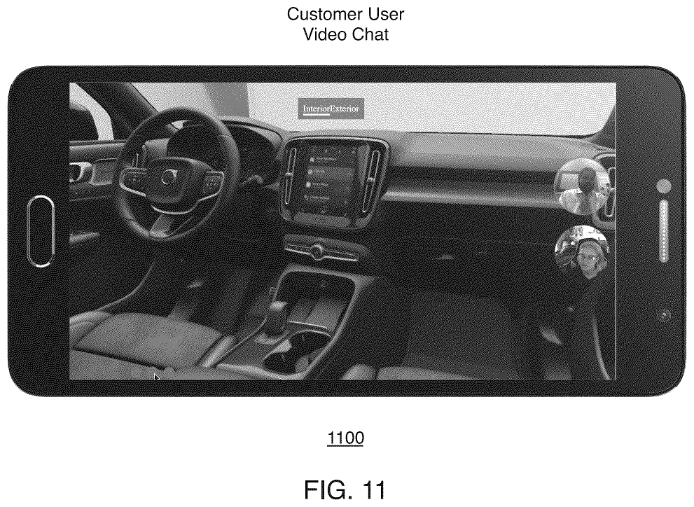

FIG. 11 is a screen shot 1100 of an example video chat, where an expert user and a customer user are viewing the interior of a vehicle at the front seats. In various embodiments, the system enables the expert user and the customer user to converse with each other via the expert user chat and customer user chat. While viewing aspects of the vehicle, the user may ask the expert questions about the vehicle, including its features. While virtually inside the vehicle, the expert may describe particular features and both the customer and expert user may manipulate relevant objects. For example, the expert user may describe the radio features while turning on the radio.

In some implementations, the system may include specialty modules such as a radio module. For example, if either user turns on the radio, the system may activate an actual radio or other music feature (e.g., CD player, streaming radio, etc.). This gives the customer user an enhanced experience in the virtual vehicle.

Another module may include cargo and/or storage modules. For example, in some embodiments, the system may provide the user with objects that represent items that a user may insert into the vehicle. Such items may include for example a stroller or a number of grocery bags. This enables the user to virtually place items in the cargo area or truck of the vehicle to get a sense of the storage space of the vehicle. The system may also provide dimensions of different spaces of the vehicle (e.g., passenger areas, trunk, frunk, etc.). In some embodiments, the system may enable the customer to customize the size of any virtual items that the customer may want to fit into different spaces of the vehicle. The system may also show how much room there is for passengers, such as showing head room in the front and rear seats, leg room in the rear seats, room for child safety seats, etc.

The system enables the expert user and the customer user to configure the vehicle using the controls in the expert user interface and the controls in the customer user interface. Such configurations enable the user to make decisions with regard to which optional features the user may want before purchasing the vehicle. In other words, the system enables the customer user to experience a virtual showroom experience that more closely resembles an actual real-world showroom experience.

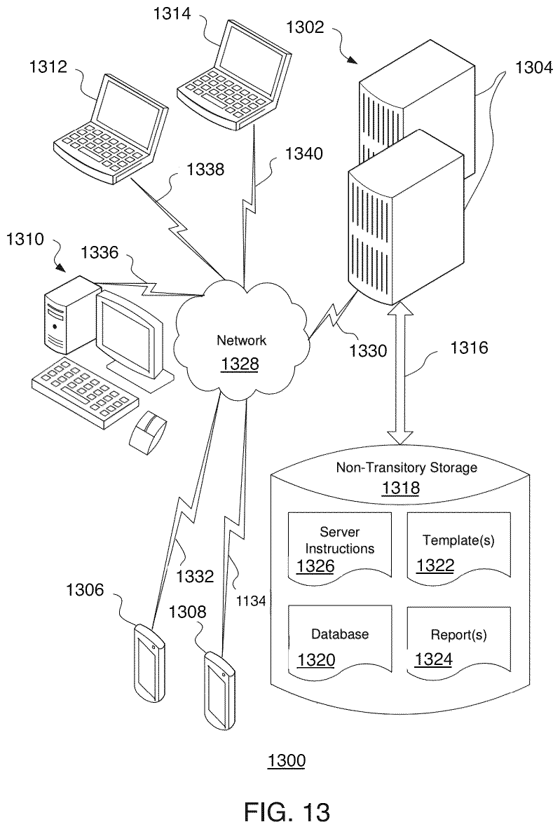

The system stores vehicle configuration data associated with the vehicle in a database of vehicle data. By storing the vehicle configuration data, the system may proceed to assist the expert user, which may be a salesperson, in closing a sale of the vehicle. Such vehicle configuration data may be stored in any suitable database associated with the system, such as database 1320 of FIG. 13, for example.

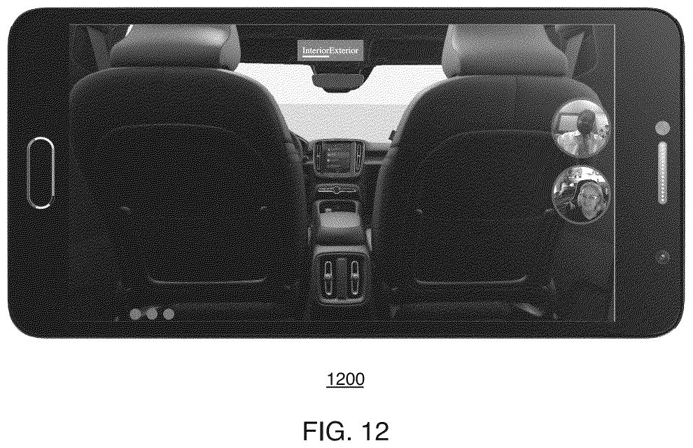

FIG. 12 is a screen shot 1200 of an example video chat, where an expert user and a customer user are viewing the interior of a vehicle at the rear seats. Shown is a view from the rear seat of the vehicle. In various embodiments, the system may enable the customer and expert users to roam the interior of the vehicle in order to view the interior from different angles and perspectives.

In various embodiments, the system provides a user with various types of virtual experiences. For example, as indicated above, the system may enable the user to have a showroom experience before he or she purchases a vehicle. In various embodiments, the system accesses a database of vehicle data. The database provides any and all features available for a particular vehicle. The system fetches, from the database, vehicle specifications of the vehicle, where the vehicle specifications include features previously selected by the customer user. The vehicle specification may vary, depending on the make and model. For example, the specification may include features may include any standard and option features or packages of features of a vehicle such as color, wheels, rims, lights such as LED lights, exterior protective coatings, sound system, etc. The system may store selected vehicle specifications for future showings of the vehicle to the customer.

In various embodiments, the system enables the expert user and the customer user to zoom in and out in the model to see specific details up close or to see how something looks from further away. In some embodiments, the system may provide transparent layers in the 3D model that enable the expert user to show aspects of the vehicle such as car engine special features without having to switch views. In another example, such transparent layers may show also high-tech systems that the customer user could see through a transparent dash, etc.

In some embodiments, the system may render side-by-side comparisons of different models or features. This may be preferred over than seeing car models in person where a customer user could not view a side-by-side comparison of various vehicle features. In some embodiments, the system may provide a notes feature that may be turned on for the 3D model and provide labels for the different features. The notes feature may enable the expert user and/or the customer user to add notes associated with one or more feature to be saved for future reference.

In some embodiments, the system may provide animated information that shows information associated with fuel efficiency, aerodynamics, wind resistance, a hybrid engine in action, etc. Such animated inform and/or visual representations of the 3D model enables the customer user to make decisions and select optional features and/or feature packages. The system may also facilitate the user in prioritizing optional features.

In some implementations, the system may also show add-on features such as bike racks, tow packages, etc., where the 3D module shows how they look on that particular vehicle. The 3D model may also guarantee that a particular add-on feature is the correct feature for the particular vehicle. In some embodiments, the system may enable the expert user and customer user to save screen shots of any of the views and save such screenshots and notes for future reference.

In another example scenario, the system may apply implementations described herein to enable a customer user to experience a product or vehicle orientation or tutorial of the features of the vehicle after purchasing the vehicle. In such a scenario, the system accesses a database of vehicle data. The system may then fetch, from the database, vehicle specifications of the vehicle. In this example, the vehicle had been purchased by the customer user. As such, the vehicle specifications may be the exact specifications matching those of the actual vehicle purchased by the customer. The system enables the expert user to conduct a vehicle orientation for the customer user. In some implementations, the system may highlight or flag particular features of interest to the customer for future reference. For example, if the customer had numerous questions about the safety features of the vehicle, the sound system, etc., the system may store such flags and enable the user to later quickly and conveniently access information relevant to such flags.

In various embodiments, the system may store the vehicle orientation in a profile associated with the user. This enables the user to access such information via their profile. In some embodiments, the system may enable the user to share or send their profile to other users such as family members who may also drive the vehicle and/or ride in the vehicle. This enables such other users to orient themselves to the features of the vehicle.

Embodiments described herein have numerous benefits. For example, embodiments enable a customer to conveniently and virtually experience a prospective vehicle before purchasing the vehicle. A dealer may show a vehicle without necessarily carrying the vehicle in inventory. Embodiments also enable a dealer or expert user to provide a virtual vehicle orientation of a purchased vehicle, which would be convenient for both the expert user and customer in terms of scheduling and eliminating the need for the customer to physically drive to the dealership.

FIG. 13 is a block diagram of an example network environment 1300 of the present disclosure. In various embodiments, a server system 1302 may include one or more server computing systems 1304 arranged in a cluster or “server farm” arrangement. In various embodiments, the server system 1302 may be used to implement the system 102 of FIG. 1, as well as to perform implementations described herein.

The server system 1302 services users of various nonportable and portable computing systems 1306, 1308, 1310, 1312, and 1314. The particular types of computing systems may vary, depending on the particular implementation. In this example embodiment, the computing systems 1306, 1308, 1310, 1312, and 1314 include smartphones (or tablets) 1306 and 1308, a desktop computer 1310, and laptop or notebook computers 1312 and 1314. The computing systems 1306, 1308, 1310, 1312, and 1314 access data maintained at a server system 1302.

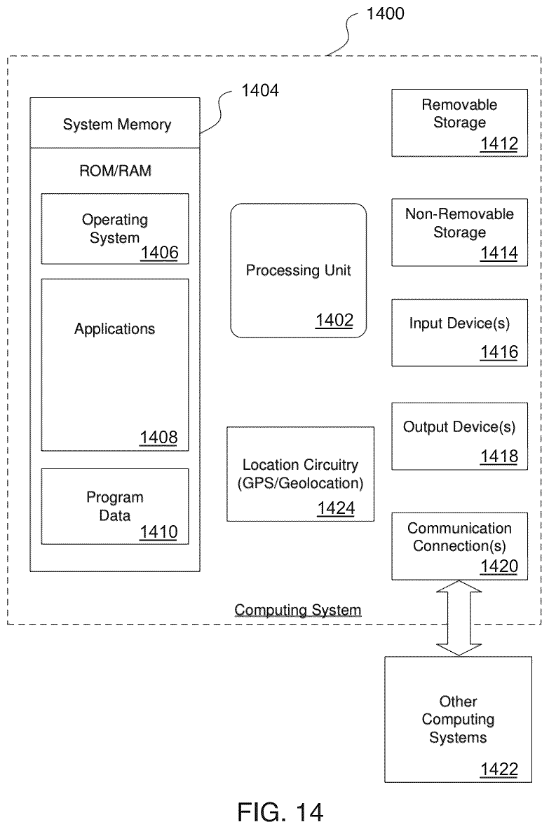

The designation “computing system” is used to generally encompass any device capable of processing instructions and accessing the server system 1302 to provide or retrieve data. A computing system as described herein is not intended to suggest any particular type of computer or other device. The computing systems 1306, 1308, 1310, 1312, and 1314 are shown for example and illustration and are not intended to be limiting. While some descriptions herein may refer to devices used by users at sites as “smartphones,” it will be appreciated that any portable device with a display and communications capabilities, such as tablets or tablet phones or other computing systems may be used in various embodiments. An example general architecture and structure of the computing systems 1306, 1308, 1310, 1312, and 1314 are described below with reference to FIG. 14.

In various embodiments, the server computing systems 1304 are coupled to a high-speed channel or bus 1316 and to a non-transitory storage 1318 that the server computing systems 1304 share or that is duplicated for each of the server computing systems 1304. The non-transitory storage 1318 may include direct access hard disk devices, solid-state memory devices, or another storage technology. In various embodiments, the non- transitory storage 1318 includes operating system software and other utilities used to operate the server computing systems 1304 and may also include a database 1320, templates 1322, storage for reports 1324, and server instructions 1326 for operating and managing access to the database 1320, templates 1322, and reports 1324.

In various embodiments, the server system 1302 is coupled to a network 1328, which may include the Internet or another computer network, via a network connection 1330 (such as a high-speed connection) to provide sufficient bandwidth to support multiple users accessing the server system 1302 with minimal latency. The computing systems 1306, 1308, 1310, 1312, and 1314 connect to the network 1328 via communications links 1332, 1334, 1336, 1338, and 1340, respectively. The communications links 1332, 1334, 1336, 1338, and 1340 may include a wireless data communications link such as provided by cellular-type communications network or a Wi-Fi network that enables communication with the network 1328. Other means of wireless communications, such as Bluetooth communications or other means of wireless communication may be used. In addition, although not commonly used with handheld computing systems 1306 and 1308, the communications links 1332, 1334, 1336, 1338, and 1340 also may include wired network connections, such as Ethernet connections. In the case of a handheld-computing systems 1306 and 1308 or another portable computing device such as laptop or notebook computing systems 1312 and 1314, Ethernet connections may be provided through a docking station (not shown). The communications links 1332, 1334, 1336, 1338, and 1340 may be continuous or switchable links that provide continual access to the network 1328 or selective, as-desired access to the network 1328, respectively.

It will also be appreciated that the server system 1302 and the network 1328 may be operated by a third-party provider, such as a commercial web services provider. The various embodiments described do not depend on any particular type of hardware or ownership of the hardware used to support the networked system herein described. In various embodiments, network environment 1300 may not have all of the components shown and/or may have other elements including other types of components instead of, or in addition to, those shown herein.

FIG. 14 is a block diagram of an example computing system 1400 of the present disclosure. The computing system 1400 may be used to implement the server system 1302 of FIG. 13 and/or the system 102 of FIG. 1, as well as to perform implementations described herein.

Referring to both FIG. 13 and FIG. 14 and given by way of illustration only and not of limitation, some form of an illustrative computing system 1400 may be used for any of the computing systems 1306, 1308, 1310, 1312, and 1314, as well as the server system 1302. In such embodiments, the computing system 1400 typically includes at least one processing unit 1402 and a system memory 1404. Depending on the particular configuration and type of computing device, the system memory 1404 may be volatile such as random-access memory (RAM), non-volatile such as read-only memory (ROM), flash memory, and the like, or some combination of volatile memory and non-volatile memory. The system memory 1404 typically maintains an operating system 1406, one or more applications 1408, and program data 1410. The operating system 1406 may include any number of operating systems executable on desktop or portable devices including, but not limited to, Linux, Microsoft Windows®, Apple OS®, or Android®. The one or more applications 1408 executed on the server system 1302 may include the server instructions 1326 for operating and managing access to the database 1320, templates 1322, and reports 1324.

The computing system 1400 may also have additional features or functionality. For example, the computing system 1400 may also include additional data storage devices (removable and/or non-removable) such as, for example, magnetic disks, optical disks, tape, or flash memory. Such additional storage may include removable storage 1412 and non-removable storage 1414. Computer storage media may include volatile and non-volatile, removable and non-removable media implemented in any method or technology for storage of information, such as computer-readable instructions, data structures, program modules or other data. The system memory 1404, the removable storage 1412, and the non-removable storage 1414 are all examples of computer storage media. Available types of computer storage media include, but are not limited to, RAM, ROM, EEPROM, flash memory (in both removable and non-removable forms) or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing system 1400. Any such computer storage media may be part of the computing system 1400.

The computing system 1400 may also have input device(s) 1416 such as a keyboard, mouse, pen, voice input device, touchscreen input device, etc. Output device(s) 1418 such as a display, speakers, printer, short-range transceivers such as a Bluetooth transceiver, etc., may also be included. The computing system 1400 also may include one or more communication connections 1420 that allow the computing system 1400 to communicate with other computing systems 1422, such as over a wired or wireless network or via Bluetooth (a Bluetooth transceiver may be regarded as an input/output device and a communications connection). The one or more communication connections 1420 are an example of communication media. Available forms of communication media typically carry computer-readable instructions, data structures, program modules or other data in a modulated data signal such as a carrier wave or other transport mechanism and include any information delivery media. The term “modulated data signal” may include a signal that has one or more of its characteristics set or changed in such a manner as to encode information in the signal. By way of illustrative example only and not of limitation, communication media may include wired media such as a wired network or direct-wired connection, and wireless media such as acoustic, radio frequency (RF), infrared and other wireless media. The term computer-readable media as used herein includes both storage media and communication media.

For individuals expected to travel to remote sites, the computing system 1400 may also include location circuitry 1424. In various embodiments, the location circuitry 1424 may include circuitry including global positioning system (“GPS”) circuitry and/or geolocation circuitry. The location circuitry 1424 may automatically discern its location based on relative positions to multiple GPS satellites and/or triangulation using cellular carrier network(s) and/or IEEE Standard 802.11 wireless (Wi-Fi) networks (collectively referred to as “geolocation services”) to determine location based on multiple cellular communications facilities and/or multiple Wi-Fi networks. The location circuitry 1424, including GPS circuitry and/or geolocation circuitry, is frequently incorporated in smartphones and many other tablets or other portable devices. As described further below, the location circuitry 1424 may be used to automatically generate location data that is usable to report a location of an individual at a site, which then may be recorded. Periodic requests for location information sent to the smartphone may indicate whether the individual is within a specified distance of the site so that the individual can be logged as being present. This type of information may be useful in evaluating the individual's performance of his or her job, to determine payment, or for other reasons. In various embodiments, computing system 1400 may not have all of the components shown and/or may have other elements including other types of components instead of, or in addition to, those shown herein.

Although the present disclosure is illustrated and described herein with reference to illustrative embodiments and specific examples provided, it will be readily apparent to those of ordinary skill in the art that other embodiments and examples may perform similar functions and/or achieve like results. All such equivalent embodiment and examples are within the spirit and scope of the present disclosure and are intended to be covered by the following non-limiting claims for all purposes.

What is claimed is:

1. A system comprising:
one or more processors; and
logic encoded in one or more non-transitory computer-readable storage media for execution by the one or more processors and when executed operable to cause the one or more processors to perform operations comprising:
activating an expert user chat in an expert user interface;
activating a customer user chat in a customer user interface;
rendering a three-dimensional (3D) model of a vehicle in the expert user interface and in the customer user interface;
rendering controls in the expert user interface that enable an expert user to manipulate the 3D model in the expert user interface; and
rendering controls in the customer user interface that enable a customer user to manipulate the 3D model in the customer user interface.

2. The system of claim 1, wherein the controls in the expert user interface and the controls in the customer user interface enable the expert user and the customer user to manipulate the 3D model simultaneously.

3. The system of claim 1, wherein the controls in the expert user interface and the controls in the customer user interface enable the expert user and the customer user to manipulate objects of the 3D model, and wherein the objects represent physical components of the vehicle.

4. The system of claim 1, wherein the controls in the expert user interface and the controls in the customer user interface enable the expert user and the customer user to manipulate objects of the 3D model, and wherein the objects represent electronic operations of the vehicle.

5. The system of claim 1, wherein the logic when executed is further operable to cause the one or more processors to perform operations comprising:
enabling the expert user and the customer user to converse with each other via the expert user chat and customer user chat;
enabling the expert user and the customer user to configure the vehicle using the controls in the expert user interface and the controls in the customer user interface; and
storing vehicle configuration data associated with the vehicle in a database of vehicle data.

6. The system of claim 1, wherein the logic when executed is further operable to cause the one or more processors to perform operations comprising:
accessing a database of vehicle data; and
fetching, from the database, vehicle specifications of the vehicle, wherein the vehicle specifications comprise features previously selected by the customer user.

7. The system of claim 1, wherein the logic when executed is further operable to cause the one or more processors to perform operations comprising:
accessing a database of vehicle data;
fetching, from the database, vehicle specifications of the vehicle, wherein the vehicle had been purchased by the customer user; and
enabling the expert user to conduct a vehicle orientation for the customer user.

8. A non-transitory computer-readable storage medium with program instructions stored thereon, the program instructions when executed by one or more processors are operable to cause the one or more processors to perform operations comprising:
activating an expert user chat in an expert user interface;
activating a customer user chat in a customer user interface;
rendering a three-dimensional (3D) model of a vehicle in the expert user interface and in the customer user interface;
rendering controls in the expert user interface that enable an expert user to manipulate the 3D model in the expert user interface; and
rendering controls in the customer user interface that enable a customer user to manipulate the 3D model in the customer user interface.

9. The computer-readable storage medium of claim 8, wherein the controls in the expert user interface and the controls in the customer user interface enable the expert user and the customer user to manipulate the 3D model simultaneously.

10. The computer-readable storage medium of claim 8, wherein the controls in the expert user interface and the controls in the customer user interface enable the expert user and the customer user to manipulate objects of the 3D model, and wherein the objects represent physical components of the vehicle.

11. The computer-readable storage medium of claim 8, wherein the controls in the expert user interface and the controls in the customer user interface enable the expert user and the customer user to manipulate objects of the 3D model, and wherein the objects represent electronic operations of the vehicle.

12. The computer-readable storage medium of claim 8, wherein the instructions when executed are further operable to cause the one or more processors to perform operations comprising:
enabling the expert user and the customer user to converse with each other via the expert user chat and customer user chat;
enabling the expert user and the customer user to configure the vehicle using the controls in the expert user interface and the controls in the customer user interface; and
storing vehicle configuration data associated with the vehicle in a database of vehicle data.

13. The computer-readable storage medium of claim 8, wherein the instructions when executed are further operable to cause the one or more processors to perform operations comprising:
accessing a database of vehicle data; and
fetching, from the database, vehicle specifications of the vehicle, wherein the vehicle specifications comprise features previously selected by the customer user.

14. The computer-readable storage medium of claim 8, wherein the instructions when executed are further operable to cause the one or more processors to perform operations comprising:
accessing a database of vehicle data;
fetching, from the database, vehicle specifications of the vehicle, wherein the vehicle had been purchased by the customer user; and
enabling the expert user to conduct a vehicle orientation for the customer user.

15. A computer-implemented method for providing vehicle demos and conversations with product experts, the method comprising:
activating an expert user chat in an expert user interface;
activating a customer user chat in a customer user interface;
rendering a three-dimensional (3D) model of a vehicle in the expert user interface and in the customer user interface;
rendering controls in the expert user interface that enable an expert user to manipulate the 3D model in the expert user interface; and
rendering controls in the customer user interface that enable a customer user to manipulate the 3D model in the customer user interface.

16. The method of claim 15, wherein the controls in the expert user interface and the controls in the customer user interface enable the expert user and the customer user to manipulate the 3D model simultaneously.

17. The method of claim 15, wherein the controls in the expert user interface and the controls in the customer user interface enable the expert user and the customer user to manipulate objects of the 3D model, and wherein the objects represent physical components of the vehicle.

18. The method of claim 15, wherein the controls in the expert user interface and the controls in the customer user interface enable the expert user and the customer user to manipulate objects of the 3D model, and wherein the objects represent electronic operations of the vehicle.

19. The method of claim 15, further comprising:
enabling the expert user and the customer user to converse with each other via the expert user chat and customer user chat;
enabling the expert user and the customer user to configure the vehicle using the controls in the expert user interface and the controls in the customer user interface; and
storing vehicle configuration data associated with the vehicle in a database of vehicle data.

20. The method of claim 15, further comprising:
accessing a database of vehicle data; and
fetching, from the database, vehicle specifications of the vehicle, wherein the vehicle specifications comprise features previously selected by the customer user.
